(19) United States
(12) Patent Application Publication
(10) Pub. No.: US 2023/0306275 A1
(43) Pub. Date: Sep. 28, 2023

(54) NEURAL NETWORK PROCESSORS

(71) Applicant: Arm Limited, Cambridge (GB)

(72) Inventors: Mauricio BRICENO, Lund (SE); Robert NORBERG, Lund (SE)

(21) Appl. No.: 18/185,918

(22) Filed: Mar. 17, 2023

(30) Foreign Application Priority Data
Mar. 24, 2022 (GB) 2204151.1

(51) Int. Cl. G06N 3/10

(52) U.S. Cl. CPC G06N 3/10

(57) ABSTRACT

Disclosed are methods of operating processor to perform neural network processing. The processor comprises a control circuit that is operable to cause an execution unit of the processor to perform tensor arithmetic operations. A program to perform neural network processing includes conditional branching instructions that cause the program execution to branch to a different part of the program when an associated branching condition is satisfied. The control circuit causes the execution unit to perform a set of one or more tensor arithmetic operations to determine a value indicative of whether a branching condition is satisfied, with the value then being communicated to the control circuit such that the control circuit, when processing the conditional branching instruction, triggers the branch (or not). Also disclosed are processors configured in this way and methods of compiling programs including such conditional branching instructions.

### CROSS-REFERENCE TO RELATED APPLICATIONS

This application claims priority pursuant to 35 U.S.C. 119(a) to United Kingdom Application No. 2204151.1, filed Mar. 24, 2022, which application is incorporated herein by reference in its entirety.

### BACKGROUND

The technology described herein relates to neural network processing, and in particular to the operation of processors that are configured to perform neural network processing such as neural processing units (NPUs).

Neural networks can be used for processes such as machine learning, computer vision, and natural language processing operations. A neural network may operate upon suitable input data (e.g. such as an image or sound data) to ultimately provide a desired output (e.g. an identification of an object within an image, or a spoken word within a sound clip, or other useful output inferred from the input data). This process may comprise an “inferencing” or “classification” process but there are various different types or arrangements of neural networks that may be used to perform different operations, as desired.

A neural network will typically process the input data (e.g. image or sound data) according to a network of operators, each operator performing a particular operation. The operations will generally be performed sequentially to produce desired output data (e.g. a classification based on the image or sound data). Each operation may be referred to as a “layer” of neural network processing.

Hence, neural network processing may comprise a sequence of “layers” of processing, such that the output from each layer is used as an input to a next layer of processing. FIG. 1 shows an exemplary sequence of layers of neural network processing from an initial input layer 101 to a final output layer 107, between which are layers comprising various convolutional layers (C-layers) 102, 103, 104, and fully-connected layers (FC layers) 105, 106.

The input layer 101 may be configured to receive input data (e.g. image or sound data), and to provide that input data in a suitable form (e.g. as an array of data elements, otherwise known as a “feature map”) for use by subsequent neural network layers. The feature map will generally comprise a three-dimensional array of data elements, each data element having data associated therewith. The feature map may have a width (W), a height (H) and a depth (C), wherein the width (W) and height (H) may be defined as the number of data elements in the width and height direction respectively, and the depth (C) may correspond to a number of data channels. For example, in the case of input data comprising an image, the width and height of the array provided by the input layer may correspond to a number of data positions (e.g. pixels) along the width and height direction of the image respectively, whilst the channels may comprise the RGB channels of the image. After the input layer, there may be one or more other layers of neural network processing (e.g. including convolutional layers, fully-connected layers, pooling layers, deconvolution layers, or any other layers of neural network processing that may be present).

Generally, a layer of neural network processing will process an input feature map (IFM) in order to generate a corresponding output feature map (OFM) (e.g. in the case of a convolutional layer, deconvolution layer, or pooling layer), or output value (e.g. a probability in the case of a fully-connected layer). The output generated by a layer of neural network processing may be used as the input for a next layer of neural network processing in the sequence, and so on. This is illustrated in FIG. 2.

The operation performed by each layer of neural network processing may comprise any suitable operation which manipulates an input (feature map) to provide an output (feature map). The operation may require process parameters (e.g. such as weights for a filter or “kernel”) which may be specific to a particular layer of neural network processing. Hence, as shown in FIG. 2, suitable process parameters (e.g. weights and biases) may be read from working memory (e.g. a buffer) 201 in order to perform each layer of neural network processing.

With reference to FIG. 1, the final layer of neural network processing in the sequence may comprise an output layer 107. The output layer may process an input feature map to generate useful output data (e.g. an inference or classification result, or an output image in the case of image processing, etc.).

Typically, data corresponding to an output feature map generated by a layer of neural network processing may be written to a suitable working memory (e.g. a buffer) 202, as shown in FIG. 2. A next layer of neural network processing may then read that data from the buffer 202 for use as an input feature map for said next layer of neural network processing, and so on.

Whilst FIG. 1 shows an example of a particular convolutional neural network with a certain arrangement of processing layers, it will be appreciated that a neural network may have various other layer arrangements and/or network architectures (e.g. the neural network could use a recurrent, or other, neural network architecture rather than convolutional neural network architecture).

Generally speaking, neural network processing involves performing various arithmetic operations. For example, when applying a filter to an input data array, the processing may comprise performing weighted sums according to a “multiply-accumulate” (MAC) operation. Typically the data structures used to represent the data to be used for the neural network processing (e.g. the input data array, the filters, the output data array, etc.) are tensors. The arithmetic operations thus typically comprise tensor arithmetic, e.g. tensor multiplication, addition, and so on.

As shown in FIG. 3, to facilitate the neural network processing, in some data processing systems, a dedicated neural network processing hardware accelerator (neural processing unit, NPU) 306 is provided as a hardware accelerator that is operable to perform such neural network processing as and when desired, e.g. in response to an application that is executing on a host processor (e.g. central processing unit (CPU)) 305 requiring the neural network processing.

The neural network processing hardware accelerator (neural processing unit, NPU), where provided, may therefore (and generally does) comprise hardware (for example comprising processing circuits) which is constructed for more efficiently performing neural network processing operations of a particular type. For example, the NPU 306 may be, and typically is, configured to perform tensor arithmetic operations, such as tensor MAC operations, and may therefore comprise a plurality of fixed-function multiply-accumulate circuits (otherwise known as a multiplier-accumulators, or “MAC units”) which are arranged to perform such MAC operations on tensor data structures.

A benefit of providing an NPU is therefore that at least these types of arithmetic operations can then be performed in a more optimised manner, e.g. using dedicated fixed-function hardware circuitry, compared to using another processor (e.g. the CPU) to perform the calculations in a general purpose manner. This also then frees up other components (e.g. the host processor (CPU)) to perform other processing tasks, as desired, which may improve the overall processing efficiency. This can be particularly important for resource constrained devices, such as mobile devices, where the CPU resource may be limited.

The NPU 306 may thus be provided along the same interconnect (bus) 307 as other hardware accelerators, such as a graphics processor (graphics processing unit, GPU) 304, such that the host processor (CPU) 305 is operable to request the NPU 306 to perform a set of neural network processing operations accordingly, e.g. in a similar manner as the host processor 305 is able to request the graphics processor 304 to perform graphics processing operations. The NPU 306 is thus a dedicated hardware unit for performing neural network processing operations on request by the host processor (CPU) 305.

The NPU 306 can thus be caused to perform neural network processing tasks on-demand for applications executing on the host processor (CPU) 305. For example, an application executing on the host processor (CPU) 305 may request the NPU 306 to perform neural network processing. A driver for the NPU 306 can then identify and determine the neural network processing to be performed, and indicate to the NPU 306 the appropriate sequence of instructions, and/or data structures for execution/use to perform the desired neural network processing.

These sequences of instructions are typically prepared in advance of the neural network processing, in an “offline” manner. For example, the desired neural network processing can be (and is) mapped onto an appropriate sequence of instructions (commands) for an executable program for the NPU 306.

Then, at runtime, in response to a request for neural network processing, the NPU 306 can load the appropriate program for execution to perform the desired neural network processing, and the NPU 306 will then work its way through the sequence of instructions (commands) in the program, executing the instructions (commands), e.g. in turn, e.g. to cause the NPU hardware to perform the tensor arithmetic operations indicated by the instructions to perform the neural network processing. The result of the neural network processing can then be returned appropriately, e.g. written out to (external, e.g. main) memory, e.g. for use by the application requiring the neural network processing.

The Applicants have identified however that there remains scope for improved methods of operating and controlling an NPU to perform neural network processing.

### BRIEF DESCRIPTION OF THE DRAWINGS

A number of embodiments of the technology described herein will now be described by way of example only and with reference to the accompanying drawings, in which:

FIG. 1 shows an exemplary sequence of layers of neural network processing comprising an input layer and an output layer, between which are neural network layers comprising various convolutional layer (C-layer) layers and fully-connected layers (FC layer);

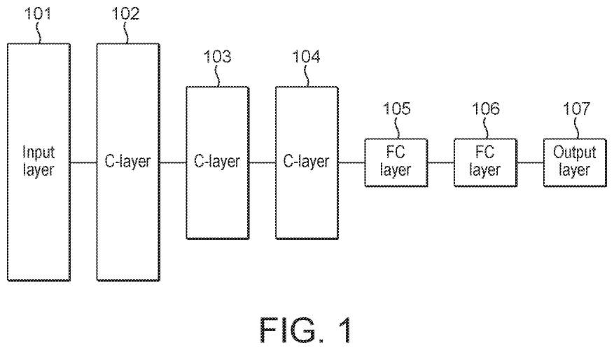

FIG. 2 illustrates a sequence of layers of neural network processing, wherein the output feature map from a layer of neural network processing may be written to a suitable buffer and then use as an input feature map for a next layer in the sequence, and wherein each layer of neural network processing may use processing parameters (e.g. such as weights) which are read from a suitable buffer;

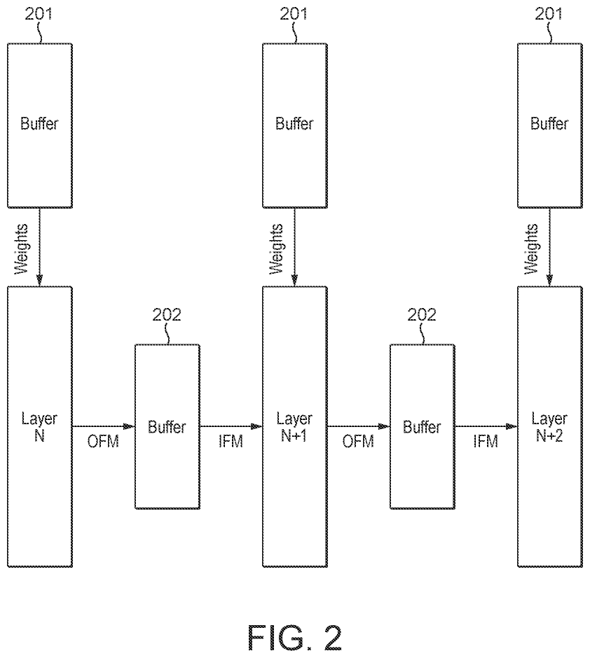

FIG. 3 shows schematically an exemplary data processing system within which embodiments of the technology described herein may be implemented;

FIG. 4 shows in more detail a neural network processing hardware accelerator (neural processing unit, NPU) according to an embodiment;

FIG. 5 is a flowchart showing a compilation process according to an embodiment of the technology described herein;

FIG. 6 is a flowchart illustrating the operation of an NPU according to an embodiment of the technology described herein; and

FIG. 7 shows further details of an NPU according to an embodiment.

Like reference numerals are used for like features in the drawings (where appropriate).

### DETAILED DESCRIPTION

A first embodiment of the technology described herein comprises a method of operating a processor that is configured to perform neural network processing (e.g. a neural network processing hardware accelerator (neural processing unit, “NPU”)),
the processor comprising:
an execution unit configured to perform tensor arithmetic operations; and
a control circuit that is operable to process sequences of instructions for programs for execution by the processor to perform neural network processing, wherein in response to processing instructions in a sequence of instructions the control circuit is operable to cause the execution unit to perform tensor arithmetic operations for the neural network processing;
the method comprising:
the control unit processing a sequence of instructions for a program for execution by the processor to perform neural network processing, the sequence of instructions including a conditional branching instruction having an associated branching condition that when satisfied will cause the program execution to branch to a different part of the program when the conditional branching instruction is encountered;
wherein the control unit processing the sequence of instructions including the conditional branching instruction includes the control unit causing the execution unit to perform a set of one or more tensor arithmetic operations to determine a value indicative of whether the branching condition for the conditional branching instruction is satisfied, the execution unit being further configured to communicate the value indicative of whether the branching condition for the conditional branching instruction is satisfied to the control unit;
the method further comprising:
when the branching condition is satisfied, the execution unit communicating to the control unit a value indicating that the branching condition is satisfied, such that when the conditional branching instruction is processed by the control unit, the conditional branching instruction triggers a branch to a different part of the program execution,
the control circuit then continuing processing instructions for the different part of the program.

A second embodiment of the technology described herein comprises a processor (e.g. a neural network processing hardware accelerator (neural processing unit, “NPU”)) comprising:
an execution unit configured to perform tensor arithmetic operations; and
a control circuit that is operable to process sequences of instructions for programs for execution by the processor to perform neural network processing, wherein in response to processing instructions in a sequence of instructions the control circuit is operable to cause the execution unit to perform tensor arithmetic operations for the neural network processing;
wherein the control circuit is configured to, when processing a sequence of instructions including a conditional branching instruction having an associated branching condition that when satisfied will cause the program execution to branch to a different part of the program when the conditional branching instruction is encountered:
cause the execution unit to perform a set of one or more tensor arithmetic operations to determine a value indicative of whether the branching condition for the conditional branching instruction is satisfied; and
the execution unit being further configured to communicate the value indicative of whether the branching condition for the conditional branching instruction is satisfied to the control unit, wherein when the branching condition is satisfied, the execution unit as a result of performing the set of one or more tensor arithmetic operations communicates to the control unit a value indicating that the branching condition is satisfied, such that when the conditional branching instruction is processed by the control unit, the conditional branching instruction triggers a branch to a different part of the program execution.

The technology described herein relates to the control and operation of a processor that is configured to perform neural network processing, such as a neural network processing hardware accelerator (or neural processing unit, “NPU”).

In embodiments, the processor that is configured to perform neural network processing is a neural network processing hardware accelerator (neural processing unit, “NPU”). Thus, any references to the processor (that is configured to perform neural network processing) may in embodiments be replaced with references to a neural network processing hardware accelerator (neural processing unit, “NPU”). As mentioned above, an NPU is a dedicated hardware accelerator that is configured to perform neural network processing operations, e.g. on request from a host processor (e.g. CPU).

Accordingly, for ease of explanation, the technology described herein will primarily be described with regard to an NPU. However, it will be appreciated that the processor that is configured to perform neural network processing in the technology described herein need not be a stand-alone NPU, but could also, for example, be coupled to another processor. Thus, the processor that is configured to perform neural network processing may be any suitable and desired processor that is configured to perform neural network processing.

Accordingly, when an application (such as a game) executing on the host processor requires neural network processing to be performed, the host processor can issue a suitable request to the NPU to trigger the NPU to perform the desired neural network processing using its processing circuits. The result of the neural network processing can then (e.g.) be returned for use by the host processor, or for further neural network processing, e.g. by writing out the result to memory (e.g. a main memory).

The benefit of this is that the NPU can be configured to perform certain types of processing operations that are commonly encountered during neural network processing in a more optimised manner, since it is dedicated for this purpose. For example, neural network processing typically involves large amounts of tensor arithmetic, e.g. multiply-accumulate (MAC) operations. The NPU can thus be (and in an embodiment is) configured to perform these tensor arithmetic operations in a more optimal manner, e.g., and in an embodiment, using fixed function processing circuits, as will be explained further below.

Thus, the processor that is configured to perform neural network processing in the technology described herein comprises an (arithmetic) execution unit that is configured to (more optimally) perform tensor arithmetic operations, e.g. of a certain type. The processor further comprises a control circuit (unit) that is operable to process instructions and schedule corresponding processing tasks for the (arithmetic) execution unit (and other processing circuits of the NPU) to perform the desired neural network processing.

In order to control the operation of the processor that is configured to perform neural network processing, the processor is therefore provided with appropriate sequences of instructions (i.e. executable programs) that can be executed by the control circuit (unit) to cause the processor's processing circuits to perform various processing operations, as desired. A desired neural network processing operation can thus be mapped onto a suitable sequence of instructions (commands) for a program for execution by an processor that when executed will cause the processor to perform the required processing operations for the neural network processing. This program compilation is in an embodiment performed in advance, e.g. in an “offline” manner, such that the processor's operation is statically scheduled.

Thus, when the processor is requested to perform neural network processing, the control circuit (control unit) of the processor is in an embodiment triggered to fetch, e.g., and in an embodiment, from memory, an appropriate sequence of instructions (a ‘command stream’) for the neural network processing in question, and then process the instructions in the sequence of instructions accordingly to operate the processor to perform the neural network processing.

The control circuit of the processor thus fetches and then parses (processes) the instructions in the sequence of instructions for the program and schedules corresponding processing tasks for the processor's processing circuits accordingly. For example, in response to a given instruction in a sequence of instructions being processed by the processor, the control circuit (unit) may schedule a corresponding processing task for the (arithmetic) execution unit of the processor, e.g. to cause the (arithmetic) execution unit to perform a tensor arithmetic operation for the neural network processing.

In some more conventional arrangements, the instructions in the sequence of instructions for a program for neural network processing may be strictly executed by the processor that is configured to perform the neural network processing in sequence, e.g. one after another, until the entire program execution is completed.

This can generally work well, especially since neural network processing is typically highly deterministic.

In some cases, however, it may be beneficial to introduce control flow operations into such neural network processing programs. This can then allow for more complex neural network processing programs to be generated and in turn allow more flexibility and greater control over the processor that is configured to perform the neural network processing, to thereby provide more optimised neural network processing by the processor.

For instance, in some cases it may be desirable to include control flow operators, such as ‘IF’, ‘ELSE’, ‘WHILE’, and other such conditions, as well as combinations thereof, into an NPU program, and to be able to perform a conditional branching accordingly, e.g. so that depending on whether or not an associated branching condition is satisfied, the program execution may jump (or not) to a different part of the program (e.g. a different (sub-)routine).

For instance, a given condition may indicate that there is no need to continue processing a certain region of an input (e.g. ‘IF’ there is little content in that region), in which case it may be better (more efficient) to branch (jump) to a different region for processing, or to execute a different (e.g. reduced) sequence of neural network processing operations for that region. Such control flow operations may therefore be especially useful when the branch condition is not known at the point at which the program is compiled (but only at execution time). In particular, this may be the case when the condition is the result of a previous processing stage. An example of this might be, for instance, to stop executing the current sub-graph (or neural network processing program) when the first processing stage has failed to detect a given object. For example, in the case of neural network processing for locating an object (e.g. person) within an image, if the result of a first neural network processing stage is that there is no such object (person) within the image, there is then no need to perform a second neural network processing stage to try to locate the object (person) within the image.

Various other examples where such conditional branching operations may be useful will be apparent to those skilled in the art.

The technology described herein provides an efficient mechanism for implementing such control flow operations into a program for execution by a processor that is configured to perform neural network processing (i.e. in the command stream for the processor).

In particular, the technology described herein provides a new type of “conditional branching” instruction that can be included into an program for a processor that is configured to perform neural network processing, and that, when processed by the control circuit (unit) of the processor, will trigger a branching operation to be performed when a branching condition associated with the instruction is determined to be satisfied.

According to the technology described herein, the determination of whether or not the branching condition is satisfied (and hence whether the conditional branching instruction should trigger a branch) is performed by the (arithmetic) execution unit of the processor as part of the program execution. In particular, this is done by reducing the logic required to make this determination to a set of one or more tensor arithmetic operations, e.g., and in an embodiment, of the same type that the (arithmetic) execution unit would normally perform during neural network processing, with the control unit then causing the (arithmetic) execution unit to perform such tensor arithmetic operations to make this determination at an appropriate point in the program execution, e.g., and in an embodiment, immediately before the conditional branching instruction (i.e. the instruction that actually triggers the branching when the condition is satisfied) is executed. The control circuit (unit) in an embodiment then waits until this determination is complete before processing the (next) conditional branching instruction.

When it is determined that the branching condition is satisfied, the (arithmetic) execution unit can then communicate that status to the control circuit (unit) accordingly. When the conditional branching instruction is encountered in the sequence of instructions, e.g., and is processed by the control circuit (unit), the conditional branching instruction can then use the determined status that the branching condition is satisfied to trigger the control circuit (unit) to perform a branching operation.

For example, the status of the branching condition determined by the (arithmetic) execution unit (i.e. satisfied/not satisfied) is in an embodiment communicated to the control circuit (unit) and when the conditional branching instruction is encountered, the control circuit (unit) is then configured to check the status, and then branch (or not) depending on the status of the branching condition.

The conditional branching instructions of the technology described herein can thus be included into a program for execution by a processor that is configured to perform neural network processing, e.g. in the normal way, and then processed by the control unit of the processor as part of the normal program execution.

However, in association with a (and each) conditional branching instruction within a sequence of instructions, the processor that is configured to perform neural network processing is also configured, e.g., and in an embodiment, by including suitable further instructions in the sequence of instructions, e.g. (immediately) before the corresponding conditional branching instruction, to cause the (arithmetic) execution unit to perform corresponding tensor arithmetic calculations to determine whether a branching condition associated with the conditional branching instruction is satisfied (such that a branch should be performed, or not).

In an embodiment, therefore, the sequence of instructions including the conditional branching instruction further includes one or more instructions to cause the (arithmetic) execution unit to perform a corresponding set of one or more tensor arithmetic operations to determine whether or not a branching condition associated with the conditional branching instruction is satisfied.

In an embodiment these further instructions are included in the sequence of instructions before, e.g. immediately before, the conditional branching instruction.

When the branching condition is determined to be satisfied, the execution of the following conditional branching instruction can then (and does) trigger a branching operation, wherein the program execution branches (jumps) to a different part of the program, as will be explained further below.

On the other hand, when the branching condition is not satisfied, the program execution can continue with the next instruction (i.e. the instruction after the conditional branching instruction) in the current sequence of instructions, without branching to a different part of the program.

Thus, the overall operation and control of the processor that is configured to perform neural network processing in the technology described herein still essentially proceeds as normal, with a control unit of the processor processing instructions in a sequence of instructions, and scheduling corresponding processing tasks (e.g.) for the (arithmetic) execution unit to perform tensor arithmetic operations, in the same way that would be done when executing ‘normal’ instructions relating to the neural network processing.

However, some of the tensor arithmetic that is performed by the arithmetic unit during the neural network processing program execution relates (only) to the determination of whether a branching condition associated with a respective conditional branching operation is satisfied, rather than to neural network processing as such.

In other words, in the technology described herein, in order to facilitate the execution of the conditional branching instructions of the technology described herein, the (arithmetic) execution unit is effectively re-purposed to perform calculations to determine whether or not an associated branching condition for a respective conditional branching instruction is satisfied, and to then communicate a status of the branching condition (i.e. satisfied/not satisfied) to the control circuit (unit) accordingly, such that when the conditional branching instruction is then processed, the control circuit (unit) can determine whether a branch should be performed, or not.

The effect of all this, therefore, is to provide a particularly low-complexity and low-area approach for implementing control flow operations within a command stream for a processor that is configured to perform neural network processing, e.g. using the existing processing circuitry of the processor to implement conditional branching operations, and, e.g., without requiring an additional dedicated unit on the processor and/or significant hardware changes to the processor for doing this.

The overall control of the processor that is configured to perform neural network processing by the host processor in the technology described herein is therefore in an embodiment performed in a similar manner as in more conventional arrangements, i.e. by having the processor that is configured to perform neural network processing execute instructions in a suitable sequence of instructions (command stream) for the neural network processing in question, with the (arithmetic) execution unit being caused to perform tensor arithmetic operations as indicated by the instructions in the neural network processing program to perform the desired neural network processing, etc. However, rather than the processor that is configured to perform neural network processing simply executing all of the instructions in the entire program in sequence, one after another, until the program execution is complete, the sequence of instructions may include one or more conditional branching instructions that when executed can then trigger a branch in the program, e.g. to cause the processor to start processing instructions for a different part of the program.

In particular, as explained above, the technology described herein uses the (arithmetic) execution unit of the processor to perform the actual determination as to whether or not a branching condition associated with a given conditional branching instruction included in a sequence of instructions for a program being executed by the processor is satisfied, and hence whether or not the conditional branching instruction should trigger a program branch.

In this regard, the present Applicants have firstly recognised that this determination can be performed in arithmetic using the (arithmetic) execution unit (e.g., and in an embodiment, using fixed function hardware circuits in the (arithmetic) execution unit to perform tensor arithmetic calculations that allow this determination to be made), and have further recognised that this approach may at least in some cases be better than other possible arrangements for implementing such control flow operations, e.g. at least in terms of reducing additional area or complexity that might otherwise be required on the processor that is configured to perform neural network processing.

For instance, in that regard, the present Applicants have recognised that for many neural network processing tasks there will typically be relatively few instances where branching may be required and that it may therefore be better (e.g. in terms of overall implementation efficiency) to use the existing (arithmetic) execution unit to perform this determination, e.g. rather than providing additional dedicated logic (e.g. hardware) on the processor to do this. That is, even though the (arithmetic) execution unit may not be optimised for performing this determination, and it may therefore be a relatively inefficient use of the (arithmetic) execution unit's processing circuitry to perform such calculations (rather than the typically more complex tensor calculations that it is optimised for), and even though using the arithmetic execution to do this may introduce processing ‘bubbles’ in the normal (neural network) command stream execution (since when the (arithmetic) execution unit is performing such calculations it is not free for performing other arithmetic for the neural network processing), this may still provide an overall improvement in terms of overall simplicity, e.g. in terms of reducing area and memory accesses requirements, e.g. compared to providing a dedicated hardware unit (circuit) on the processor that is operable to perform this determination.

The technology described herein may thus provide various benefits compared to other possible approaches.

In the technology described herein, as mentioned above, a sequence of instructions for a program for a processor that is configured to perform neural network processing includes one or more conditional branching instructions that when executed can trigger a branch to a different part of the program. Further, the conditional branching instructions are each associated with a respective branching condition. Whether or not the branch operation is triggered by execution of a particular conditional branching instruction within a sequence of instructions will therefore depend on whether the respective branching condition associated with the instruction is satisfied.

During the program execution, when such conditional branching instructions are to be processed by the control circuit (unit) of the processor, a determination should thus have been made (and in the technology described herein is made) as to whether or not the branching condition is satisfied, and hence whether or not the execution of the conditional branching instruction should actually trigger a branch to a different part of the program.

As explained above, this determination of whether the branching condition is satisfied is made by the processor causing the (arithmetic) execution unit to perform one or more calculations (using ordinary tensor arithmetic operations) that determine whether the branching conditions is satisfied. In an embodiment, this is done by executing appropriate instructions that have been correspondingly included into the neural network processing program for this purpose.

Thus, the sequence of instructions for the program to be executed by the processor that is configured to perform the neural network processing in an embodiment also includes a corresponding set of one or more further instructions that when processed by the control circuit (unit) will trigger the (arithmetic) execution unit to perform tensor arithmetic operations to determine whether or not the branching condition is satisfied.

This set of further instructions is in an embodiment included in the sequence of instructions before the conditional branching instruction itself (the instruction that actually triggers the branching, or not, depending on whether the branching condition is satisfied), e.g., and in an embodiment, immediately before the conditional branching instruction, such that when the conditional branching instruction is encountered, this determination has already been made, and the result of this determination can thus be used to trigger the branch operation (or not).

An aspect of the technology described herein is thus the recognition that the computations to determine whether or not the branching condition is satisfied can be replicated in ordinary tensor arithmetic operations that can therefore be performed by the (arithmetic) execution unit of the processor.

The actual determination as to whether the branching condition is satisfied can be performed in any suitable manner, as desired, e.g. depending on the operator (condition) in question. That is, for a given branching condition, it is possible to determine a suitable sequence of tensor arithmetic operations that determine whether or not the branching condition is met.

For example, this determination will typically (and in an embodiment) involve determining a value, associated with the condition, which value can then be used (e.g. as a predicate value) when executing the conditional branching instruction itself to determine whether or not the branching condition is met, and hence whether a branch should be performed. Thus, in embodiments, the (arithmetic) execution unit performing tensor arithmetic to determine whether or not the branching condition is satisfied comprises the (arithmetic) execution unit calculating a suitable value for this purpose.

In particularly embodiment, the result of the tensor arithmetic performed by the (arithmetic) execution unit in this respect is a binary result (i.e. a single bit value) indicating either that the branching condition is or isn't satisfied.

Thus, in embodiments, the (arithmetic) execution unit is caused to reduce the determination of whether or not the branching condition is satisfied to a single bit output value (i.e. indicating ‘branching—yes’ or ‘branching—no’). That is, in embodiments, the (arithmetic) execution unit performing the set of one or more tensor arithmetic operations to determine whether the branching condition for the conditional branching instruction is satisfied comprises the (arithmetic) execution unit calculating a single bit value indicating whether or not the branching condition is satisfied, the single bit value being communicated to the control circuit, and used as input to the conditional branching instruction to determine whether or not a branch should be performed.

In an embodiment, this single bit value is then communicated to the control circuit (unit) and the control circuit (unit) stores the status of the branching condition appropriately, e.g. with the status being set to ‘1’ if the branching condition is satisfied (and ‘0’ otherwise).

In that case, the processing of the conditional branching instruction by the control circuit (unit) may, e.g., and in an embodiment does, involve a zero/non-zero check. That is, once it has been determined by the tensor arithmetic performed by the (arithmetic) execution unit that the branching condition is satisfied, and this has been communicated to the control circuit (unit) accordingly, such that the branching condition status is set (e.g.) to ‘1’, the control circuit (unit) processing the conditional branching instruction may then comprise checking the branching condition status, and when the status is non-zero, triggering a branch operation.

Thus, in embodiments, the determined (e.g. non-zero) status of the branching condition is used as the branch condition predicate for the conditional branching instruction.

However, various other arrangements would be possible, and the processing of the conditional branching status to check whether or not the branching condition is satisfied may comprise any suitable and desired check, e.g. depending on how the status of the branching condition is communicated to the control circuit (unit).

For example, rather than a zero/non-zero check, this could also involve comparing a value indicative of the branching condition to any other suitable threshold or value, as desired.

In general, the comparisons and tensor arithmetic operations that are performed in this regard may be selected suitably, e.g. based on the configuration of the execution unit, based on a suitable reduction of the calculations to determine whether or not the branching condition is met into ordinary tensor arithmetic operations, e.g. of the type that the execution unit is configured to perform.

By including a suitable set of instructions that when processed by the control circuit (unit) will cause the control circuit (unit) to cause the (arithmetic) execution unit to perform a corresponding set of tensor arithmetic operations that determine such a value indicative of whether the branching condition is satisfied, the determined value can then be communicated to the control circuit (unit) and then used accordingly when processing the following conditional branching instruction to determine whether to trigger a branching operation (or not, depending on whether the condition is satisfied). In an embodiment, a corresponding signal line is therefore provided between the (arithmetic) execution unit and the control circuit (unit) for communicating the status of the branching condition. For instance, where the (arithmetic) execution unit determines this status as a single bit value (as in embodiments), this can be communicated by setting the signal line high/low appropriately. Various other arrangements would be however be possible.

When the branching condition is satisfied, the execution of the conditional branching instruction should (and does) trigger a branch in the program. The processing of the conditional branching instruction therefore in an embodiment involves checking the status of the branching condition, and then initiating a branch, or not, depending on the status of the branching condition. Thus, if the branching condition is not satisfied, a branch is not performed, and the control circuit (unit) in an embodiment continues executing instructions in the current sequence of instructions (for the current part of the program), e.g., and in an embodiment, by executing the next instruction after the conditional branching instruction.

On the other hand, if the branching condition is satisfied, a branch is performed to a different part of the program, and the control circuit (unit) then continues the program execution from the start of (i.e. the first instruction in a sequence of instructions for) the different part of the program, e.g. by executing instructions from a branch offset, e.g., and in an embodiment, indicated by the conditional branching instruction. Thus, in embodiments, the conditional branching instruction indicates a respective branch offset identifying the start of the different part of the program, e.g., and in an embodiment, by identifying the position in the overall sequence of instructions for the program of the first instruction in that part of the program.

When a branch operation is to be performed, the control circuit (unit) in an embodiment then stops fetching instructions for the current part of the program, flushes the current sequence of instructions, and starts fetching instructions for the different part of the program, e.g. starting from the branch offset. The control circuit (unit) then continues executing instructions from the start of the different part of the program.

In some cases, the processor that is configured to perform the neural network processing may need to wait before triggering the branch operation. In particular, this may be the case where the processor is currently processing part of a bigger job.

For instance, in some embodiments, the neural network processing involves subdividing the processing of an initial input data array into one or more, and in an embodiment a plurality of, blocks/sub-blocks. The processor that is configured to perform the neural network processing may then be caused to execute the neural network processing operations for the blocks/sub-blocks, and in an embodiment one after another, until the sequence of operations has been completed for the entire initial input data array. This may be done in any suitable and desired manner. In an embodiment, the processor that is configured to perform the neural network processing is caused to perform a desired sequence of operations for a first block/sub-block of the initial input data array, and then for a next block/sub-block of the initial input data array, and so on.

In that case, when a conditional branching instruction is encountered when processing a first block/sub-block, which conditional branching instruction would trigger a program branch (since the associated branching condition is satisfied), the processor is in an embodiment caused to continue processing the other blocks/sub-blocks, at least up to the position of the conditional branching instruction in the sequence of instructions, before the branch operation is triggered for the entire initial input data array. That is, in an embodiment, when the control circuit (unit) encounters a conditional branching instruction, the operation in an embodiment stalls until all of the processing jobs for the initial input data array are completed before determining whether or not to branch. In such cases, rather than determining a value to be used for determining whether or not the branching condition is satisfied for each block/sub-block, a block/sub-block may inherit a previously determined and stored value from a previous block/sub-block, for example.

Various other arrangements would be possible.

The use of such conditional branching instructions according to the technology described herein may therefore provide a particularly efficient, low complexity, approach for implementing such control flow operations in a program for execution by a processor that is configured to perform neural network processing.

The instructions for the neural network processing program, including the conditional branching instructions of the technology described herein, may be prepared in any suitable and desired manner. In an embodiment these are prepared and then issued to the processor that is configured to perform the neural network processing, e.g., and in an embodiment, in the normal way, e.g. as part of a command stream for the processor.

In an embodiment, the command streams (sequences of instructions) that are to be executed by the processor are stored in memory, e.g. main memory, in an embodiment together with various data structures for the neural network processing. The processor that is configured to perform the neural network processing is thus in an embodiment configured to read in the command streams from this (e.g. main) memory.

In embodiments, the preparation of commands (instructions) to be executed by the processor for performing the neural network processing is done by a compiler for the processor, which compiler is, e.g., and in an embodiment, executed on a host processor (e.g. CPU) of the data processing system. In embodiments, the compiler comprises a compiler circuit, comprising a programmable processing circuit that is appropriately programmed to perform the required compiler operation.

Thus, in an embodiment, the compiler is configured to, and operates to, based on the neural network processing to be performed, prepare and store appropriate sequences of commands (instructions) and in an embodiment also associated data structures for causing a processor to perform the neural network processing in the manner of the technology described herein.

The compiler may execute as part of a driver operation for the processor that is to perform the neural network processing (for example, executing in response to a request for neural network processing by an e.g. application, e.g. executing on a host processor (CPU) of the data processing system).

The compiler execution may be performed in advance of any execution of and performing of the neural network processing itself, in an “offline” manner. Thus the compilation process is in an embodiment done in advance of runtime, rather than at runtime for the neural network in question. Correspondingly, the compiler in an embodiment executes separately and in advance of running the driver (the driver operation for the processor that is to perform the neural network processing).

In this latter case, the compiler operation will accordingly, and in an embodiment, prepare in advance data structures, sequences of commands, etc., for performing neural network processing in the manner of the technology described herein, which data structures, sequences of commands, etc., can then be stored for future use.

Then, e.g. at runtime, the, e.g., driver, will identify and determine the neural network processing to be performed (e.g. based on a request for neural network processing, e.g. from an application requiring neural network processing, e.g. executing on a host processor (CPU) of the data processing system), and issue the appropriate sequence of instructions, and/or data structures to the processor for execution/use to perform the desired neural network processing.

In the technology described herein the compiler is therefore configured to include, in the sequences of instructions that it is preparing for the neural network processing, conditional branching instructions, as described above.

The technology described herein extends to compiler operation in the manner of the technology described herein per se.

Hence, a further embodiment of the technology described herein comprises a compiler for compiling a neural network program to be executed by a processor (e.g. neural network hardware accelerator (neural processing unit, “NPU”)) to perform neural network processing, the compiler comprising:
a neural network analysing circuit configured to, for a neural network comprising a set of plural neural network processing operations to be performed:
determine any instances where a conditional branching operation may be desired to be performed when processing the neural network; and
a command generating circuit configured to:
generate a sequence of instructions for execution by the processor to perform neural network processing, wherein in response to executing instructions in the sequence of instructions, a control circuit of the processor is operable to cause an execution unit of the processor to perform tensor arithmetic operations for the neural network processing,
wherein when generating a sequence of instructions, the command generating circuit is configured to include within the sequence of instructions, at a position in the sequence where the neural network analysing circuit has determined that a conditional branching operation may be desired to be performed, a conditional branching instruction having an associated branching condition that when satisfied will cause the program execution to branch to a different part of the program when the conditional branching instruction is encountered,
the command generating circuit also configured to include within the sequence of instructions further instructions to cause the control circuit of the processor to cause the use the execution unit of the processor to perform a set of one or more tensor arithmetic operations to determine a value indicative of whether the branching condition is satisfied.

Another embodiment of the technology described herein comprises a method of compiling a neural network program to be executed by a processor (e.g. a neural network hardware accelerator (neural processing unit, “NPU”)) to perform neural network processing, the method comprising:
for a neural network comprising a set of plural neural network processing operations to be performed:
determining any instances where a conditional branching operation may be desired to be performed when processing the neural network; and
the method further comprising:
generating a sequence of instructions for execution by the processor to perform neural network processing, wherein in response to executing instructions in the sequence of instructions, a control circuit of the processor is operable to cause an execution unit of the processor to perform tensor arithmetic operations for the neural network processing,
wherein generating the sequence of instructions comprises including within the sequence of instructions, at a position in the sequence where it has been determined that a conditional branching operation may be desired to be performed, a conditional branching instruction having an associated branching condition that when satisfied will cause the program execution to branch to a different part of the program when the conditional branching instruction is encountered,
the method also comprising including within the sequence of instructions further instructions to cause the control circuit of the processor to cause the execution unit to perform a set of one or more tensor arithmetic operations to determine a value indicative of whether the branching condition is satisfied.

As will be appreciated by those skilled in the art, these further embodiments of the technology described herein can, and in an embodiment do, comprise any one or more or all of the optional features of the technology described herein described herein, as appropriate.

Thus, the compiler (compilation process) is in an embodiment further configured to include in the sequence of instructions further instructions that cause the arithmetic execution to perform the calculations to determine whether the branching condition is satisfied, e.g., and in an embodiment, by reducing this logic to a set of calculations that give a single bit output that can then be used (e.g. as a predicate) for the conditional branching instruction. In an embodiment the status of the branching condition is then communicated to the control circuit (unit) of the processor that is performing the neural network processing accordingly, e.g. as described above, and used as input (e.g. as a predicate value) for the conditional branching instruction.

The conditional branching instructions that are included by the compiler (compilation process) in an embodiment correspond to the conditional branching instructions described above, i.e. in that they cause the processor to operate in the manner described above. Thus, the conditional branching instructions included in the sequence of instructions in an embodiment indicate a respective branch offset identifying the start of (i.e. the first instruction in a sequence of instructions for) the different part of the program that the program execution should branch to when the branch is performed.

Once the commands (command stream) for the entire neural network to be executed has been prepared, they may be stored, for example, in (e.g. main) memory, and then the commands (in the command stream) provided therefrom to the processor that is to execute the neural network for execution, with the processor then executing the commands to execute the neural network accordingly.

In an embodiment, as well as preparing suitable commands to cause the processor that is configured to perform the neural network processing to execute the neural network in the desired manner, any appropriate data structures, e.g. comprising the desired input feature maps and/or weight arrays (filters) to be used for the neural network, are in an embodiment also prepared and, e.g., and in an embodiment, stored appropriately in memory.

The sequences of commands and the appropriate data (e.g. input feature maps and weight arrays) to perform the neural network processing can then be retrieved from memory, and, e.g., executed and used by the processor that is to perform the neural network processing to perform the desired neural network processing.

Once the commands (the command stream) and the data structures (if required) for the neural network processing have been prepared and, e.g., stored in the memory, then the processor can be triggered and caused to perform the corresponding neural network processing. As discussed above, this is in an embodiment triggered by the, e.g. driver for the processor, issuing the appropriate sequence of commands and/or data structures to the processor for execution/use to perform the desired neural network processing, with the processor (control circuit (unit)) then executing the commands (e.g. in sequence), to perform the neural network processing using the appropriate data structures).

To facilitate this, the processor that is configured to perform the neural network processing in an embodiment includes an appropriate control circuit (e.g., and in an embodiment, the control circuit (unit) mentioned above) for controlling the operation of the processor, that can, for example, and in an embodiment, load commands to be executed from memory, execute those commands, and control the functional units, etc., of the processor to operate accordingly in response to the commands (as they are executed).

The control circuit (unit) in an embodiment also controls memory write outs. For instance, in normal operation of the processor that is configured to perform the neural network processing, when performing a layer of neural network processing, a result of the neural network processing is in an embodiment then written out to memory, e.g. for use by the next layer of neural network processing. Thus, a memory access unit of the processor is in an embodiment triggered to write out the results of the arithmetic operations performed by the (arithmetic) execution unit. In the technology described herein, however, the control circuit (unit) is in an embodiment operable to selectively disable such memory write outs.

In that respect, the present Applicants recognise that the results of the tensor arithmetic operations that are performed solely in order to determine whether or not a conditional branch can (and should) be performed do not need to be written out, as these results are only used to trigger a program branch (or not), but have no further use outside of the immediate program execution. Further, these data structures (tensors) can be relatively large. Thus, to save memory bandwidth, the control circuit is in an embodiment operable to prevent writing out to memory data that is associated (only) with the conditional branching instructions.

Thus, in embodiments, the control circuit of the processor that is configured to perform neural network processing comprises a selective memory write-out control that is operable to selectively disable memory write out operations for certain instructions. That is, in embodiments, the control unit is operable to (selectively) prevent the (arithmetic) execution unit from writing out the results of the set of one or more tensor arithmetic operations, and in an embodiment prevents writing out the results of the set of one or more tensor arithmetic operations to determine whether the branching condition for the conditional branching instruction is satisfied to memory.

In order to support this operation, the processor that is configured to perform neural network processing (and in an embodiment the control circuit of the processor) is in an embodiment operable to, and configured to, recognise in a sequence of instructions (a command stream) to perform neural network processing, a set of instructions relating to a conditional branching instruction (i.e. the conditional branching instruction itself as well as any preceding instructions that determine whether the conditional branching condition is satisfied), and to selectively disable memory write out for these instructions.

This can be done in various suitable ways, as desired. In an embodiment, the new conditional branching instructions include an indication (e.g. a flag or other suitable indicator) that memory write out should be disabled. Thus, the indication (flag) can be set accordingly to disable memory write out for any instructions associated with the conditional branching. On the other hand, for any normal instructions that relate to neural network processing as such, memory write out should be enabled, and the indication (flag) can be set accordingly (or the indication may not be present to cause memory write out to proceed in the normal way).

Other arrangements would of course be possible. For instance, the sequence of instructions could also include explicit instructions to trigger the memory access unit to write out to memory, in which case the absence of such instructions may prevent memory write out.

The memory that is operable to and used to store data for neural network processing in the technology described herein can be any suitable and desired (e.g. main) memory of the data processing system (that is suitable, and used for, inter alia, for storing data, inter alia, relating to neural network processing).

The memory that is used in the technology described herein should be, and is in an embodiment, memory that is external to the processor that is performing the neural network processing (e.g. the NPU), e.g. main memory. It should be, and is in an embodiment, memory that is accessed from and by the processor that is configured to perform neural network processing via a (its) bus interface.

The memory of the data processing system is correspondingly in an embodiment memory that is accessed by the NPU via an appropriate memory access unit or units, and in an embodiment via one or more direct memory access (DMA) units. Thus the processor that is configured to perform neural network processing in an embodiment has associated with it (and in an embodiment comprises) one or more direct memory access (DMA) units (via which it can and will access data in the main memory).

The memory may be any suitable type of memory. The memory in an embodiment comprises random access memory (RAM), e.g. such as SRAM, DRAM, and/or SDRAM.

The memory may, and in an embodiment does, comprise several actual (physical) memories (i.e. may be distributed across several different “memories” within the overall data processing system), and can comprise both on-chip and/or off-chip memory (and in an embodiment comprises both on- and off-chip memory).

In an embodiment, at least part of the (main) memory that is used in the technology described herein is on-chip with the processor that is performing the neural network processing (which on-chip memory will accordingly be faster to access and lower power than off-chip). In an embodiment, the memory comprises, at least in part, on-chip SRAM.

The NPU in an embodiment also comprise at least some local storage. The local storage associated with the processor that is to perform the neural network processing can comprise any suitable and desired local storage of that processor. The local storage should be, and is in an embodiment, physically (and logically) separate from the main memory. The local storage should be, and is in an embodiment, storage that is internal to the processor that is performing the neural network processing and/or can in an embodiment be accessed by processing unit(s) of the processor directly (without the need for a memory access unit (e.g. DMA) and not via any bus interface (in contrast to the main memory)).

Subject to the requirements of the technology described herein, the processor that is configured to perform neural network processing may be configured in any suitable and desired manner, e.g. that a processor for performing neural network processing may normally be configured for.

For instance, a processor that is configured to perform neural network processing (e.g. an NPU) is typically (and in embodiments) configured to perform certain types of operations that are commonly encountered during neural network processing.

The processor that is configured to perform neural network processing should, and in an embodiment does, include appropriate processing circuits, logic, etc., suitable for performing neural network processing operations. Thus the processor in an embodiment comprises, inter alia, processing circuit(s) configured to apply a filter to an input data array and in an embodiment to perform a weighted sum using input data and weight data. In an embodiment, the processor comprises appropriate circuit(s) for performing the weighted sum. In an embodiment, the processor is configured to perform a weighted sum as a multiply-accumulate operation, and accordingly the processor comprises one or more multiply-accumulate circuits (otherwise known as a multiplier-accumulator, or an “MAC unit”) for performing a multiply-accumulate operation.

In an embodiment, the processor that is configured to perform neural network processing comprises a plurality of multiply-accumulate circuits (MAC units), in an embodiment arranged in parallel.

In an embodiment, the processor (the relevant processing circuits, e.g. MAC unit(s) of the processor) is configured (constructed) particularly to perform particular, in an embodiment selected, in an embodiment predetermined, neural network processing operations in an efficient manner, and most in an embodiment configured for applying a filter to an input data array in a particular, in an embodiment selected, in an embodiment predetermined manner. In an embodiment these processing circuits are fixed-function processing circuits.

In an embodiment, the (processing circuits of the) processor that is configured to perform neural network processing is configured to (optimised to most efficiently) apply a filter to an input data array according to a particular, in an embodiment selected, in an embodiment predetermined, stride (corresponding to a number of data positions in the x and y directions respectively between sets of data positions of the input data array to which the filter is applied). The processor may be particularly configured to use any suitable stride, but in particularly embodiment is configured to use a 1×1 stride.

In an embodiment it is these processing circuits that are used to perform the determinations described above for determining whether or not a branch operation can (and should) be performed.

The processor that is configured to perform neural network processing may otherwise be configured as desired and may, e.g., have any of the usual or desired features for a neural network processing hardware accelerator (NPU).

A benefit of the technology described herein, however, is that minimal hardware changes are required to the processor in order to implement the conditional branching operation.

For instance, as explained above, the (arithmetic) execution unit is operable to communicate to the control circuit (unit) a status of a branching condition, e.g. in order to allow the control circuit (unit) when processing a conditional branching instruction to determine whether or not a branch should be performed. There may therefore be an additional signal path for communicating this information and the control circuit (unit) may comprise additional logic that is configured to track the status of the branching condition. However, other than this, there is in an embodiment minimal additional hardware that is dedicated for the purposes of the technology described herein, with the existing (arithmetic) execution unit instead being re-purposed for determining the branching conditions when such conditional instructions are encountered, e.g. as described above.

As mentioned above, the processor that is configured to perform neural network processing may be provided as part of an overall data processing system.

The data processing system may be implemented as part of any suitable electronic device which may be required to perform neural network processing, e.g., such as a desktop computer, a portable electronic device (e.g. a tablet or mobile phone), or other electronic device. Thus the technology described herein also extends to an electronic device that includes the data processing system of the technology described herein (and on which the data processing system operates in the manner of the technology described herein). The data processing system of the present may, in an embodiment, be implemented as part of a portable electronic device (such as a mobile phone, tablet, or other portable device).

The data processing system may comprise any desired components and elements that a data processing system can comprise, such as one or more or all of: a display processing unit (display processor), a central processing unit (CPU), a graphics processing unit (GPU) (graphics processor), a video processor, a digital signal processor, one or more neural network processors, a display and a memory.

The processors may be arranged within a system-on-chip system.

The memory of the data processing system may comprise memory for storing data, inter alia, relating to neural network processing. For example, the memory may store data for input data arrays, output data arrays, and weight data arrays. The memory may comprise one or more local memories, which may be located on-chip. The local memory may comprise one or more caches.

The memory may also comprise a main memory, which may be an external memory which may be located off-chip. The main (external) memory may be any suitable type of memory, such as SDRAM for example.

The data processing system (and in particular the processors of the data processing system) may be operable to access data which is present in a local memory (cache) when performing neural network processing. The data processing system may be operable to request data to be transferred from main (external) memory to local memory if data that is required is not already present in the local memory. The data processing system may comprise one or more circuits for transferring data from main memory to local memory (and for transferring data from local memory to main memory), e.g. such as one or more a direct memory access (DMA) units which may be associated with the processor which is to perform the neural network processing.

The technology described herein may be used in conjunction with any suitable and desired neural network. In embodiments, the neural network is a convolutional neural network.

The neural network processing which is to be performed may comprise any suitable operation which modifies an input data array to generate a corresponding output data array. In embodiments, the neural network processing may relate to an “inferencing” or “classification” process. However, there are various different types or arrangements of neural networks that may be used to perform different operations, as desired, and the technology described herein may find utility in any suitable such applications. The technology described herein may also be used during a training process.

The neural network processing which is to be performed may be part of (or may comprise) a layer of neural network processing. The layer of neural network processing may be one of plural layers of neural network processing which are performed in sequence. The layer of neural network processing in question may comprise a first layer in a sequence of plural layers. Alternatively, the layer of neural network processing in question may comprise a layer which is not the first layer (is an intermediate layer) in a sequence of plural layers. Each layer of neural network processing may process an input data array (input feature map) to generate an output data array (output feature map), wherein when plural layers of neural network processing are to be performed in sequence, one after the other, the output data array generated by a layer is used at least in part as an input data array for a next layer in the sequence.

The neural network processing which is to be performed may be part of (or may comprise) a layer of neural network processing which is a convolution layer, a deconvolution layer or a pooling layer of a neural network.

The input data array which is to be processed according to the neural network processing may be any suitable array of input data (input feature map). The input data array may comprise an array of (plural) data positions, each data position having one or more data values associated therewith.

The input data array which is processed may comprise an entire input data array which is stored in memory and which is to be processed according to a layer of neural network processing, for example an entire input feature map. Alternatively, the input data array which is being processed may comprise (only) part of an overall input data array (e.g. which is stored in memory), e.g. where an overall input data array is processed as a plurality of portions (tiles) making up the overall input data array. In this case, each portion (tile) of the input feature map is in an embodiment respectively processed in the manner of the technology described herein.

Hence, the input data array which is processed may comprise a region of a larger input data array (the larger input data array corresponding to for example an entire input feature map to be processed by a layer of neural network processing), wherein said larger input data array may be divided into any suitable number of regions (tiles) for processing by the processor.

The neural network processing may perform processing for each input data array corresponding to a region of a larger input data array, e.g. in turn, thereby operating a tile-based processing scheme (in which each tile corresponds to a region of the larger input data array).

Accordingly, the input data array which is processed may comprise (at least part of) an input feature map for a layer of neural network processing.

The output data array (which is generated by the neural network processing from the input data array) may correspondingly comprise (at least part of) an output feature map for the layer of neural network processing. The output data array may comprise an array of data positions, each data position having one or more data values associated therewith. The output data array may be written to memory, or may be provided directly to a processor for use as an input data array, for example when processing a subsequent layer of neural network processing.

The input feature map may correspond to (or be derived from) any suitable data which is received by the data processing system for processing according to neural network processing in order to generate a useful output such as, for example, an image, an image from an Image Signal Processor (ISP), an image frame from video data, sound data or voice data, or other input data. Correspondingly the neural network processing which is to be performed by the processor may contribute to identifying or classifying features present within the data (initially) received by the data processing system, e.g. such as objects in an input image, or sound features in input sound data. Alternatively, the neural network processing which is to be performed by the processor may contribute to training the neural network.

The data processing system may comprise and/or be in communication with one or more memories (such as the memories described above) that store the data described herein, and/or store software for performing the processes described herein. The data processing system may comprise and/or be in communication with a host microprocessor, and/or with a display for displaying output data associated with the neural network processing.

The data processing system of the technology described herein may be implemented as part of any suitable system, such as a suitably configured micro-processor based system. In some embodiments, the technology described herein is implemented in a computer and/or micro-processor based system.

The various functions of the technology described herein may be carried out in any desired and suitable manner. For example, the functions of the technology described herein may be implemented in hardware or software, as desired. Thus, for example, the various functional elements of the technology described herein may comprise a suitable processor or processors, controller or controllers, functional units, circuits, processing logic, microprocessor arrangements, etc., that are operable to perform the various functions, etc., such as appropriately dedicated hardware elements (processing circuits) and/or programmable hardware elements (processing circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing circuits may share processing circuits, etc., if desired.

It will also be appreciated by those skilled in the art that all of the described embodiments of the technology described herein may include, as appropriate, any one or more or all of the features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on data processor, a computer program element comprising computer software code portions for performing the methods herein described when the program element is run on data processor, and a computer program comprising code adapted to perform all the steps of a method or of the methods herein described when the program is run on a data processing system.

The technology described herein also extends to a computer software carrier comprising such software which when used to operate a data processing system causes in a processor, or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

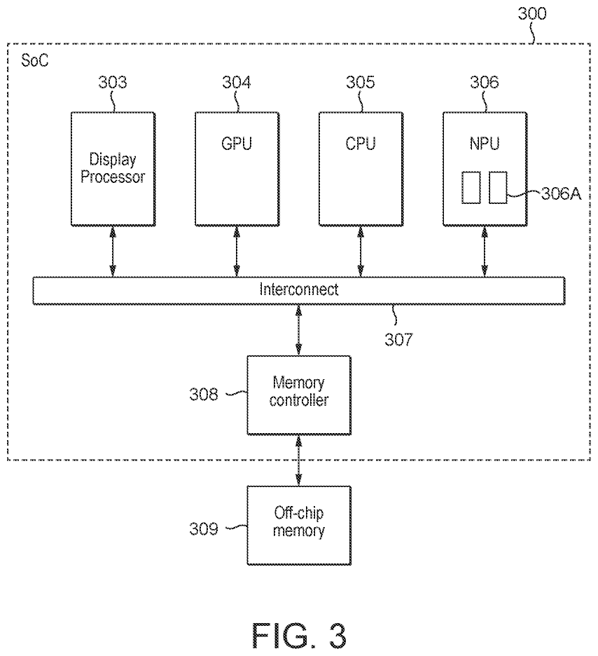

FIG. 3 shows an exemplary system on-chip (SoC) data processing system 300 within which the technology described herein can be employed. As shown in FIG. 3, the data processing system 300 in the present embodiment comprises a host processor in the form of a central processing unit (CPU) 305, a graphics processor (GPU) 304, a display processor 303, a neural network processing hardware accelerator (neural processing unit, NPU) 306 and a memory controller 308. As shown in FIG. 3, these units communicate via an interconnect 307 and have access to off-chip memory 309.

In this system, the graphics processor 304 will, for example, render frames (images) to be displayed, and the display processor 303 will then provide the frames for output, e.g. to a display panel for display.

Correspondingly, the neural network processing hardware accelerator (neural processing unit, NPU) 306 will perform neural network processing. The neural network processing hardware accelerator (neural processing unit, NPU) 306 comprises circuits (hardware) (e.g. such as multiply-accumulate circuits 110) which are specifically configured to most efficiently perform neural network processing in a particular predetermined manner. The neural network processing hardware accelerator (neural processing unit, NPU) 306 is thus designed to perform certain types of neural network processing operations in an optimised manner.

The data processing system 300 may of course include any other components or processing units that may be desired. For instance, the data processing system 300 may further comprise an image signal processor (ISP), a video decoder, an audio codec, etc., or any other components that a data processing system 300 may desirably have. A sensor may provide input data for the system 300 (e.g. video data and/or sound data from a suitable camera or microphone or other sensor device).

Likewise, the data processing system 300 need not contain all of the components or processing units illustrated in FIG. 3. Furthermore, although FIG. 3 shows a stand-alone neural network processing hardware accelerator (neural processing unit, NPU) 306 (and embodiments will accordingly be described in relation to the same), it will be appreciated that the processor that is configured to perform the neural network processing need not be a stand-alone unit, but could also be coupled to one of the other processors.

The present embodiments in particular relate to the control of the neural network processing hardware accelerator (neural processing unit, NPU) 306. In the present embodiments, the neural network processing hardware accelerator (neural processing unit, NPU) 306 is controlled to perform neural network processing by having the neural network processing hardware accelerator (neural processing unit, NPU) 306 execute an appropriate sequence of instructions to cause the processing circuits of the neural network processing hardware accelerator (neural processing unit, NPU) 306 to perform desired processing operations.

These sequences of instructions are typically prepared in advance, and in an “offline” manner, e.g. by the central processing unit (CPU) 305, and stored in memory, together with associated data structures for the neural network processing. Thus, when an application executing on the central processing unit (CPU) 305 requires neural network processing, a suitable request is then issued to the neural network processing hardware accelerator (neural processing unit, NPU) 306 to cause the neural network processing hardware accelerator (neural processing unit, NPU) 306 to load the appropriate program and/or data structures from memory for execution.

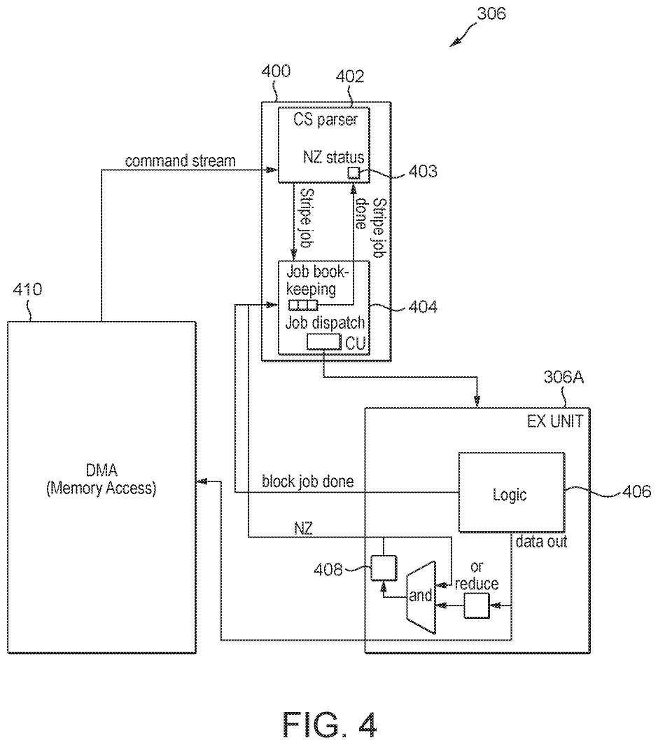

FIG. 4 shows more detail of a neural network processing hardware accelerator (neural processing unit, NPU) 306 according to an embodiment. As shown in FIG. 4, the neural network processing hardware accelerator (neural processing unit, NPU) 306 includes a control circuit (unit) 400 comprising a command stream frontend 402 that is operable to parse instructions within an NPU command stream as they are read in from memory (via direct memory access (DMA) unit 410) and distribute processing jobs to the neural network processing hardware accelerator (neural processing unit, NPU) 306 processing circuitry accordingly. To track these jobs, the control circuit (unit) 400 also therefore comprises a job controller 404 that is operable to manage processing jobs and schedule processing jobs for the neural network processing hardware accelerator (neural processing unit, NPU) 306 processing circuitry.

For example, in response to an instruction in an NPU command stream, the job controller 404 may schedule a corresponding processing task for the arithmetic execution unit 306 of the neural network processing hardware accelerator (neural processing unit, NPU) 306, which in this example is provided in the form of a plurality of fixed-function multiply-accumulate circuits 406. Once a desired tensor arithmetic operation has been performed, the resulting data can then be provided to the direct memory access (DMA) unit 410 accordingly for writing out.

Thus, when performing neural network processing, the command stream frontend 402 works through the instructions in the NPU command stream, processing them accordingly to determine the processing jobs that should be scheduled, and the job controller 404 then causes the arithmetic execution unit 306A (multiply-accumulate circuit 406) to perform tensor arithmetic as required in order to perform the desired neural network processing.

The instructions in the NPU command stream are thus generally executed in sequence, in this way. The present embodiments however relate particularly to the implementation of control flow operations within the sequences of instructions being executed by the neural network processing hardware accelerator (neural processing unit, NPU) 306.

In particular, this is done by including within a sequence of instructions within an NPU command stream a respective “conditional branching” instruction that when executed can trigger the NPU control circuit (unit) 400 to perform a branch operation, where execution of the sequence of the instructions for the current part of the program is stopped, and program execution jumps (branches) to a different part of the program.

In the present embodiments, this branching may or may not be performed depending on whether an associated branching condition for the instruction is satisfied.

Thus, when a conditional branching instruction is encountered, the command stream frontend 402 should check whether or not the associated branching condition is satisfied, and then perform a branch operation, or not, accordingly, based on this check.

The determination of the status of the branching condition in the present embodiment is performed as part of the normal command stream execution, in particular by having the arithmetic execution unit 306A (multiply-accumulate circuit 406) perform suitable tensor arithmetic to make this determination. That is, this determination is reduced to ordinary tensor arithmetic operations that can then be performed by the arithmetic execution unit 306A (multiply-accumulate circuit 406), e.g. by including suitable instructions in the command stream to schedule this work.

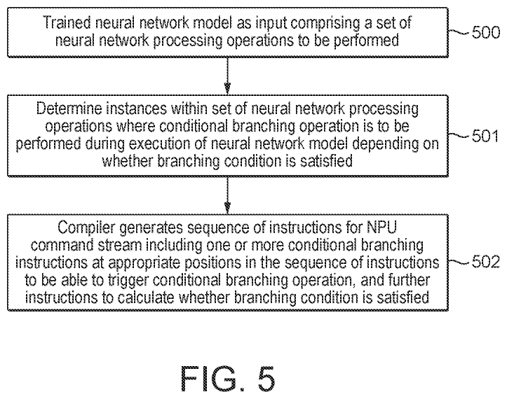

FIG. 5 thus shows how a set of instructions (a command stream) for causing the neural network processing hardware accelerator (neural processing unit, NPU) 306 to operate in the manner of the present embodiments is generated in the present embodiments. This process will be performed by an appropriate compiler for the neural network processing hardware accelerator (neural processing unit, NPU) 306, that will accordingly generate the sequence of commands to be executed by the neural network processing hardware accelerator (neural processing unit, NPU) 306 to perform the desired neural network processing.

The compiler may execute, for example, on the CPU 305 (e.g. as part of a driver for the neural network processing hardware accelerator (neural processing unit, NPU) 306) of the overall data processing system. Additionally or alternatively, the compilation process may be performed “offline”, for example on a separate processor and data processing system to the system that includes the neural network processing hardware accelerator (neural processing unit, NPU) 306, with the compiled sequence of commands for the neural network then being stored appropriately in a memory for subsequent execution by the neural network processing hardware accelerator (neural processing unit, NPU) 306 when the neural network processing is required.

As shown in FIG. 5, the process for generating a command stream to trigger operation in the manner of the present embodiments takes an appropriate description (definition) of the neural network processing that is required (such as the ML (machine learning) network graph) as an input (step 500).

For example, a trained neural network that is provided as input may comprise the following set of neural network processing operations, in pseudo-code:

If (cond( )) {
ofm1 = op1( )
ofm2 = op2(ofm1)
} else {
ofm2 = op2b( )
}
ofm3 = op3(ofm2);

Thus, in this example, if the branching condition (‘cond( )’) is satisfied, a first sequence of neural network processing operations are performed (i.e. perform a first operation (‘op1( )’) to determine a first output result (‘ofm1’), which first output result (‘ofm1’) is then processed accordingly by a second operator (‘op2’) to generate a second output result (‘ofm2’)). On the other hand, if the condition is not satisfied, the second output result (‘ofm2’) is determined using a different operation (‘op2b( )’). After this conditional operation, a further processing operation is performed on the second output result (‘op3(ofm2)’) to give a third output result (‘ofm3’).

It will be appreciated that this is merely a simple example to illustrate how control flow operations may be included within a neural network model. Various other arrangements would of course be possible. Further, a typical neural network model will of course contain many more processing operations, e.g. depending on the neural network in question.

The compilation process essentially maps the neural network model onto a suitable sequence of instructions for execution by the neural network processing hardware accelerator (neural processing unit, NPU) 306). As part of this, the compiler determines any instances within the model where a conditional branching operation (e.g. the IF/ELSE operation in the example above) should be performed (step 501).

The compiler can then generate a sequence of instructions for an executable NPU program and includes within the sequence of instructions, at the appropriate positions within the sequence, corresponding “conditional branching” instructions that when executed can cause the neural network processing hardware accelerator (neural processing unit, NPU) 306 to perform a branching operation, or not, depending on whether an associated branching condition is satisfied (step 502). In order to implement this conditional branching, the compiler in the present embodiment also includes a further instruction or instructions to cause the arithmetic execution unit to calculate a value indicative of whether or not the branching condition is satisfied.

For the example given above, the compiler may thus generate an executable program, e.g. as follows:

Res = compute_cond1( )
compute_cond2(Res)
Branch_if_one(one_label)
ofm2 = op2b( )
Branch(end_label)
One_label:
ofm1 = op1( )
ofm2 = op2(ofm1)
End_label:
Ofm3 = op3(ofm2);

This program can then be executed by the neural network processing hardware accelerator (neural processing unit, NPU) 306, e.g. in the manner described above, in order to control the neural network processing hardware accelerator (neural processing unit, NPU) 306.

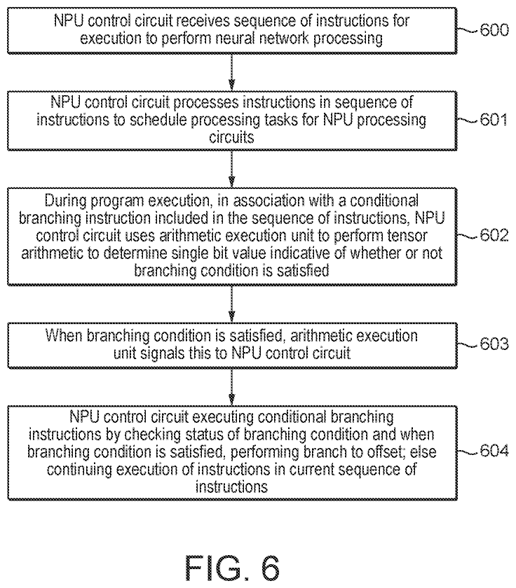

FIG. 6 shows how a set of instructions (a command stream) may be executed by the neural network processing hardware accelerator (neural processing unit, NPU) 306 to operate in the manner of the present embodiments.

As shown in FIG. 6, the neural network processing hardware accelerator (neural processing unit, NPU) 306 receives the sequence of instructions for execution. As explained above, these instructions are in an embodiment fetched in via direct memory access (DMA) unit 410 by the command stream frontend 402 executing on the NPU control circuit (unit) 400 (step 600).

The command stream frontend 402 executing on the NPU control circuit (unit) 400 then processes the instructions in the sequence of instructions and schedules corresponding processing tasks for the NPU processing circuitry (e.g. the arithmetic execution unit 306A) (step 601).

During the program execution, in response to encountering the sequence of instructions in the example given above, the arithmetic execution unit 306A is caused to calculate a suitable value indicate of whether or not the branching condition is satisfied (e.g. by the command stream frontend 402 executing the first two instructions in the sequence, and computing the result accordingly).

In the present embodiments, the first two instructions (‘Res=compute_cond1( )’ and ‘compute_cond2(Res)’) when executed thus cause the arithmetic execution unit 306A to compute a suitable value that is indicative of whether the branching condition is satisfied, and that can be signalled to the control circuit (unit) 400 appropriately for use as input to the (next) conditional branching instruction. To do this the arithmetic execution unit 306A reduces this determination to a single bit value (e.g. ‘1’ is the branching condition is satisfied, else ‘0’) (step 602). This single bit value is then signalled to the control circuit (unit) 400 by a suitable unit 408 within the arithmetic execution unit 306A that is configured to do this, as shown in FIG. 4 (step 603). The status of the branching condition (i.e. zero/non-zero) is then stored appropriately 403 for use by the command stream frontend 402.

The command stream frontend 402 continues processing the instructions in the sequence of instructions and the next instruction that is encountered is the conditional branching instruction (i.e. ‘Branch_if_one(one_label)’). This instruction causes the command stream frontend 402 to check the status 403 of the branching condition, and if the branching condition status is set (i.e. is satisfied), the job controller 404 is caused to stop issuing jobs for the current sequence of instructions, and a new sequence of instructions for the branch part of the program are then fetched and processed accordingly (step 604).

To facilitate this, the conditional branching instruction includes as its argument (‘one_label’) the branch offset indicating the position of the instruction that the execution should jump (branch) to when the branching condition is satisfied.

On the other hand, if the branching condition status is not set (satisfied) when the conditional branching instruction is encountered, the program execution continues, e.g. with the next instructions in the current sequence of instructions (i.e. ‘End_label: Ofm3=op3(ofm2)’).

Thus, in the present embodiments, the instructions to determine whether the branching condition is satisfied (‘compute_cond1’ and ‘compute_cond2’) are issued as ordinary tensor arithmetic operations, and processed by the arithmetic execution unit 306A in the normal way. When the conditional branching instruction (‘Branch_if_one(one_label)’) is then encountered, the command stream frontend 402 waits for the arithmetic execution unit to complete its calculation as to whether the branching condition is met, and then reads the appropriate status 403 to decide whether or not a branch should be performed.

It will be appreciated that in an NPU (and in the neural network processing hardware accelerator (neural processing unit, NPU) 306 of the present embodiment) the results/operands are normally too big to fit in a register bank and so are streamed directly to/from memory, e.g. via direct memory access (DMA) unit 410. Thus, in normal NPU operation, all of the processing results would be written out to memory.

In the present embodiments however the control circuit (unit) 400 is operable to selectively disable the output to memory, on a per instruction (operation) basis. For example, in the example given above, the result of the compute_cond2 operation should not be written out to memory because it is not used for anything else than deciding whether to branch or not, and the control circuit (unit) 400 is thus configured to disable memory write out at this point (with the result therefore being discarded after the branch has been performed (or not)).

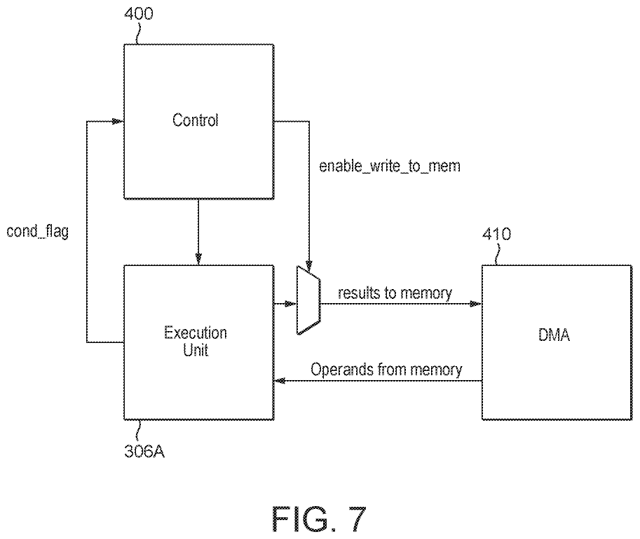

FIG. 7 shows the selective disabling of memory write out according to an embodiment. As shown in FIG. 7, the arithmetic execution unit 306A is configured to directly read in operands from memory via direct memory access (DMA) unit 410.

The arithmetic execution unit 306A is also operable to write out results to memory in this way. However, rather than always directly writing results out to memory (as may be the case in some other more conventional arrangements), in the present embodiment the control circuit (unit) 400 is operable to selectively enable write to memory, by signaling this appropriately to a write out control unit provided logically between the arithmetic execution unit 306A and the direct memory access (DMA) unit 410, as shown in FIG. 7.

In this respect, the data structures (tensors) generated by the arithmetic execution unit 306A are typically large (which is why they are normally written out directly to memory) and so avoiding this where unnecessary can provide significant improvements in terms of reducing memory bandwidth and allocation.

This operation can be controlled in various ways. For example, in embodiments, this is controlled by including in the instructions themselves suitable flags, or indicators, that indicate whether or not memory write out should be enabled. Various other arrangements would of course be possible.

The present embodiments therefore may provide various benefits and improvements compared to other possible approaches.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

What is claimed is:

1. A method of operating a processor that is configured to perform neural network processing,
the processor comprising:
an execution unit configured to perform tensor arithmetic operations; and
a control circuit that is operable to process sequences of instructions for programs for execution by the processor to perform neural network processing, wherein in response to processing instructions in a sequence of instructions the control circuit is operable to cause the execution unit to perform tensor arithmetic operations for the neural network processing;
the method comprising:
the control unit processing a sequence of instructions for a program for execution by the processor to perform neural network processing, the sequence of instructions including a conditional branching instruction having an associated branching condition that when satisfied will cause the program execution to branch to a different part of the program when the conditional branching instruction is encountered;
wherein the control unit processing the sequence of instructions including the conditional branching instruction includes the control unit causing the execution unit to perform a set of one or more tensor arithmetic operations to determine a value indicative of whether the branching condition for the conditional branching instruction is satisfied, the execution unit being further configured to communicate the value indicative of whether the branching condition for the conditional branching instruction is satisfied to the control unit;
the method further comprising:
when the branching condition is satisfied, the execution unit communicating to the control unit a value indicating that the branching condition is satisfied, such that when the conditional branching instruction is processed by the control unit, the conditional branching instruction triggers a branch to a different part of the program execution,
the control circuit then continuing processing instructions for the different part of the program.

2. The method of claim 1, wherein the execution unit performing the set of one or more tensor arithmetic operations to determine a value indicative of whether the branching condition for the conditional branching instruction is satisfied comprises the execution unit calculating a single bit value indicating whether or not the branching condition is satisfied, the single bit value being communicated to the control circuit, and used as input to the conditional branching instruction to determine whether or not a branch should be performed.

3. The method of claim 1, wherein the control unit prevents the execution unit from writing out the results of the set of one or more tensor arithmetic operations to determine a value indicative of whether the branching condition for the conditional branching instruction is satisfied to memory.

4. The method of claim 1, wherein the conditional branching instruction includes an indicator that memory write out should be selectively disabled.

5. The method of claim 1, wherein the conditional branching instruction indicates the start of the different part of the program.

6. The method of claim 1, wherein the execution unit comprises one or more fixed function tensor arithmetic units, and wherein the one or more fixed function tensor arithmetic units are used to determine whether the branching condition for the conditional branching instruction is satisfied.

7. The method of claim 6, wherein the one or more fixed function tensor arithmetic units are configured to perform multiply-accumulate operations.

8. A processor comprising:
an execution unit configured to perform tensor arithmetic operations; and
a control circuit that is operable to process sequences of instructions for programs for execution by the processor to perform neural network processing, wherein in response to processing instructions in a sequence of instructions the control circuit is operable to cause the execution unit to perform tensor arithmetic operations for the neural network processing;
wherein the control circuit is configured to, when processing a sequence of instructions including a conditional branching instruction having an associated branching condition that when satisfied will cause the program execution to branch to a different part of the program when the conditional branching instruction is encountered:
cause the execution unit to perform a set of one or more tensor arithmetic operations to determine a value indicative of whether the branching condition for the conditional branching instruction is satisfied;
the execution unit being further configured to communicate the value indicative of whether the branching condition for the conditional branching instruction is satisfied to the control unit, wherein when the branching condition is satisfied, the execution unit as a result of performing the set of one or more tensor arithmetic operations communicates to the control unit a value indicating that the branching condition is satisfied, such that when the conditional branching instruction is processed by the control unit, the conditional branching instruction triggers a branch to a different part of the program execution.

9. The processor of claim 8, wherein the execution unit performing the set of one or more tensor arithmetic operations to determine a value indicative of whether the branching condition for the conditional branching instruction is satisfied comprises the execution unit calculating a single bit value indicating whether or not the branching condition is satisfied, the single bit value being communicated to the control circuit, and used as input to the conditional branching instruction to determine whether or not a branch should be performed.

10. The processor of claim 8, wherein the control unit is operable to prevent the execution unit from writing out the results of the set of one or more tensor arithmetic operations to determine whether the branching condition for the conditional branching instruction is satisfied to memory.

11. The processor of claim 10, wherein the conditional branching instruction includes an indicator that memory write out should be selectively disabled.

12. The processor of claim 8, wherein the conditional branching instruction indicates the start of the different part of the program, and wherein when a conditional branching instruction triggers a branch to a different part of the program execution, the control unit is caused to start processing instructions from the indicated start of the different part of the program.

13. The processor of claim 8, wherein the execution unit comprises one or more fixed function tensor arithmetic units, and wherein the one or more fixed function tensor arithmetic units are used to determine whether the branching condition for the conditional branching instruction is satisfied.

14. The processor of claim 13, wherein the one or more fixed function tensor arithmetic units are configured to perform multiply-accumulate operations.

15. A method of compiling a neural network program to be executed by a processor to perform neural network processing, the method comprising:
for a neural network comprising a set of plural neural network processing operations to be performed:
determining any instances where a conditional branching operation may be desired to be performed when processing the neural network; and
the method further comprising:
generating a sequence of instructions for execution by the processor to perform neural network processing, wherein in response to executing instructions in the sequence of instructions, a control circuit of the processor is operable to cause an execution unit of the processor to perform tensor arithmetic operations for the neural network processing,
wherein generating the sequence of instructions comprises including within the sequence of instructions, at a position in the sequence where it has been determined that a conditional branching operation may be desired to be performed, a conditional branching instruction having an associated branching condition that when satisfied will cause the program execution to branch to a different part of the program when the conditional branching instruction is encountered,
the method also comprising including within the sequence of instructions further instructions to cause the control circuit of the processor to cause the execution unit of the processor to perform a set of one or more tensor arithmetic operations to determine a value indicative of whether the branching condition is satisfied.

16. The method of claim 15, wherein the further instructions that are included in the sequence of instructions to cause the control circuit of the processor to use the execution unit of the processor to perform a set of one or more tensor arithmetic operations to determine whether the branching condition is satisfied, cause the execution unit to calculate a single bit value indicating whether or not the branching condition is satisfied, such that the determined single bit value can be communicated to the control circuit, and used as input to the conditional branching instruction to determine whether or not a branch should be performed.

17. The method of claim 15, wherein the conditional branching instruction includes an indicator that memory write out should be selectively disabled to prevent the execution unit from writing out the results of the set of one or more tensor arithmetic operations to determine whether the branching condition for the conditional branching instruction is satisfied to memory.

18. The method of claim 15, wherein the conditional branching instruction indicates the start of the different part of the program that the program execution should branch to.

19. A computer program comprising instructions which, when the program is executed is executed by a processor, cause the processor to carry out the method of claim 1.
